(19) United States
(12) Patent Application Publication
(10) Pub. No.: US 2025/0040556 A1
(43) Pub. Date: Feb. 6, 2025

(54) METHOD FOR THE PRODUCTION OF PROTEIN AND FIBER RICH AIRY FOOD PRODUCT

(71) Applicant: Zero Carb Company B.V., Wageningen (NL)

(72) Inventors: Eral OSMANOGLOU, Wageningen (NL); Wouter Matthijs FRANKEN, Wageningen (NL)

(21) Appl. No.: 18/924,347

(22) Filed: Oct. 23, 2024

Related U.S. Application Data
(62) Division of application No. 16/623,670, filed on Dec. 17, 2019.

(30) Foreign Application Priority Data
Jun. 23, 2017 (NL) 2019117

(51) Int. Cl. A21D 13/066; A23L 29/269; A23L 33/12; A23L 33/185; A23L 33/19; A23L 33/21

(52) U.S. Cl. CPC A21D 13/066; A23L 29/27; A23L 33/12; A23L 33/185; A23L 33/19; A23L 33/21

(57) ABSTRACT

The invention relates to a baked food product comprising a protein, a dietary fiber, water, a stabilizer, and optionally a digestible carbohydrate, wherein the baked food product comprises at least 30 wt % of the protein based on a dry matter weight, wherein at least 50 wt % of the protein consist of albumin, and wherein a weight ratio of the protein to the dietary fiber is selected in the range of 0.75-4, wherein the food product is a gluten-free food product, and wherein a weight ratio of the optional digestible carbohydrate to protein is equal to or less than 0.15. Further, a process for the production of such food product and a baking composition obtainable by the process is described.

### CROSS-REFERENCE TO RELATED APPLICATION(S)

This application is a divisional application of U.S. application Ser. No. 16/623,670, filed Dec. 17, 2019. U.S. application Ser. No. 16/623,670 is a U.S. national-stage application, under 35 U.S.C. § 371, of International Application No. PCT/NL2018/050405, filed Jun. 22, 2018, which in turn claims priority to Dutch Patent Application No. 2019117, filed Jun. 23, 2017. Each of these applications is incorporated herein by reference for all purposes.

### FIELD OF THE INVENTION

The invention relates to a production process for the production of a baked food product, the baked food product per se, and a baking composition for the production of a baked food product.

### BACKGROUND OF THE INVENTION

Low carbohydrate and or high protein baked food products are known in the art. EP0642737, e.g., describes a gluten-free bread, characterized by the fact that it is produced from gluten-free flour and eggs, and optionally baking powder and baker's yeast.

US2006141126, e.g., describes high protein and high fiber food products, additives for preparing high protein and high fiber food products, and methods of making high protein and high fiber food products are disclosed. More particularly, the additives and methods described seem useful for preparing high protein and high fiber bread products. The additives comprise protein and/or fiber, at least one hydrocolloid, oil, and water and may optionally comprise minerals and emulsifiers.

US2014161963 describes a 0-net carbohydrate all-purpose baking flour high in protein and fiber content and low in fat and calorie content. In a preferred embodiment, the proteins and fibers are blended together in the presence of a bonding agent. The resulting 0-net carbohydrate baking flour preferably further includes a natural sweetener. The 0-net carbohydrate flour can be prepared so as to be gluten free. In the document, the term “net carbs” represents the total amount of carbohydrates in a particular food that can be absorbed and digested in the intestinal tract, and “0-net carbohydrate” means the value of the net carbs in ⅛ or ¼ cup of flour or other food is about zero or below zero.

### SUMMARY OF THE INVENTION

Many gluten-free products and low carbohydrates products on the market today may still comprise a significant amount of carbohydrates. In other state of the art products, flour has at least partly been replaced by soy flower and/or isolates/concentrates. Further, state of the art low carbohydrate products have a texture that does not resemble the texture of the high carbohydrate products they mimic. Many consumers do not prefer the structural (textural) and/or sensory (organoleptic) properties of state of the art high protein/low carbohydrate baked products.

Hence, it is an aspect of the invention to provide an alternative food product and also a process for the production of such food product, that preferably further at least partly obviate(s) one or more of the above-described drawbacks. It is further an aspect of the invention to provide a baking composition, especially for the baked food product described herein. The present invention may have as object to overcome or ameliorate at least one of the disadvantages of the prior art, or to provide a useful alternative.

In a first aspect, the invention provides a baked food product (“food product” or “product”) comprising a protein, a (dietary) fiber, water, optionally a stabilizer, and optionally a digestible carbohydrate, especially a starch, wherein the baked food product especially comprises at least 30 wt % of the protein based on a dry matter weight (of the food product), and especially wherein a weight ratio of the protein to the (dietary) fiber is selected in the range of 0.75-4 (0.75:1-4:1). Especially, the food product is a (substantially) gluten-free food product (see below). Especially, the weight ratio of the optional digestible carbohydrate, especially the starch, to the protein is less than 0.2, such as equal to or less than 0.15, especially equal to or less than 0.1, such as equal to or less than 0.05, like equal to or less than 0.025, like especially equal to or less than 0.02, such as even more especially equal to or less than 0.015 (based on a dry matter weight (of the food product). An amount of the digestible carbohydrates in the baked food product may be equal to or lower than 2.5 wt %, especially equal to or lower than 1.5 wt % (relative to a total weight of the baked food product).

The term “carbohydrates” may relate to an organic compound comprising single, double or multiple sugar units. Such compound may be divided in digestible compounds (“digestible carbohydrates”), especially (simple) sugars and starches, and non-digestible compounds (“non-digestible carbohydrates”), especially fibers. The food product especially comprises a low starch and low sugar food product. Hence, the food product may comprise a low digestible carbohydrate food product, comprising a low amount of digestible carbohydrates (relative to the remainder, especially the amount of protein, of the food product). Herein, the term “carbohydrate” such as used in the phrase “low carbohydrate” or “ratio of the carbohydrate to the protein” (or fibers, etc.) may especially relate to a “digestible carbohydrate”, even more especially to a starch and/or a sugar (compound). A (digestible) carbohydrate may also relate to more than one (different) (digestible) carbohydrate.

Such food product may be (referred to as) a low carbohydrate food product, having an appearance and sensory properties comparable to an analogous high carbohydrate baked food product. Alternatively, it may be referred to as a low digestible carbohydrate food product. Such food product may also be known (nowadays) as a “low carb” food product. Such product may be used (consumed) as an alternative to a high (digestible) carbohydrate product, especially comprising a substantial amount of digestible carbohydrates, especially a starch and/or a sugar. The food product may advantageously be integrated in a dict. The product may comprise substantially no digestible carbohydrates and a minimal amount of fat. The energy per serving may come for the major part from the protein. Furthermore, the fibers in the product may provide a health benefit, especially on the intestines. The product, especially because of the high protein and the fibers content, may have a positive effect on (perception of) satiety. Furthermore, because the product may not comprise starch, it may not suffer from retrogradation, e.g., when stored in a refrigerator. The product may be stored in a refrigerator and may have a longer shelf life than comparable alternatives produced from starchy material.

In embodiments, the weight ratio of the optional digestible carbohydrate, especially the starch, to the protein is especially equal to or less than 0.5, such as equal to or less than 0.1. In embodiments, said weight ratio is equal to or less than 0.05. In embodiments, the food product does substantially not comprise any digestible carbohydrate. Especially, the amount of digestible carbohydrate may be selected in the range of 0.01-2 wt %, such as 0.01-1 wt %, relative to the total weight of the baked food product. In embodiments, the amount of digestible carbohydrates in the baked food product is equal to or lower than 1.5 wt %, especially equal to or lower than 1 wt % (relative to the total weight of the baked food product). In further embodiments, the amount of digestible carbohydrates in the baked food product on a dry matter base is equal to or lower than 2 wt %, especially 1.5 wt % (relative to the total dry matter weight of the baked food product). In embodiments (if the digestible carbohydrate is available) a weight ratio of the digestible carbohydrate to the protein is equal to or less than 0.05 (based on the dry matter weights).

The product may further comprise a flavor preferred by the consumer, especially without off-flavors known from presently marketed products. The product may be preferred by the consumer as a durable alternative for the product being mimicked (by the food product of the invention). Especially, the food product may have a high score for overall acceptability in a sensory evaluation by consumers. The product may essentially comprise a protein and a fiber (and water). A total weight of the protein may be larger than a total weight of the fiber. Yet, in other embodiments, the total weight of the protein is smaller than the total weight of the fiber. In further embodiments, the weight ratio of the protein to the dietary fiber is selected in the range of 0.75-3, (0.75:1-3:1) such as in the range of 0.85-3 (0.85:1-3:1). In embodiments, said ratio is larger than or equal to 1. The ratio of protein to dietary fiber may in embodiments be selected in the range of 1:1-2:1 (on a dry matter weight base).

In an embodiment, the product may comprise a bread-like texture (structure) (such product also being referred herein as “bread analogue”). In further embodiments, the product may comprise a cake-like texture (“cake analogue”). Yet in other embodiments, the product may comprise a cookie-like texture (“cookie analogue”) or a cracker-like texture (“cracker analogue”). Hence, in an embodiment the food product comprises a bread analogue. The product may comprise bread of loaf and/or a bun-like and/or roll-like product. In a further embodiment, the food product comprises a cake analogue. Yet in a further embodiment, the food product comprises a cookie analogue or a cracker analogue. In an embodiment, the food product comprises a Melba toast analogue. Hence, the baked food product may comprise a food product selected from the group consisting of (an analogue of) a bread, a bun, (a roll,) a cookie, a cake, and a cracker. In an embodiment the baked food product comprises (especially, is) a cookie. In a further embodiment, the baked food product comprises (is) a cake. In yet another embodiment, the food product comprises (is) a cracker.

Especially the food product comprises an amount of protein based on a dry matter weight (of the food product) selected to be equal to or more than 30 wt %, such as equal to or more than 40 wt %, especially equal to or more than 50 wt %, such as selected in the range of 50-75 wt %. In embodiments, the food product comprises equal to or less than 60 wt %, such as equal to or less than 50 wt %, especially equal to or less than 45 wt % protein based on the dry matter weight. Herein, the percentages depicted are especially on dry matter basis, unless indicated otherwise or unless clear from the context (such as especially for the baking composition (see below)).For instance, it may be indicated by relating it to a “total weight”. Reference is made to the total weight especially for the baking composition, and less frequently for the food product. When indicated as relative to the “total weight”, without any indication of dry matter or dry weight, the weight especially relates to a weight including moisture/water. For instance, “relative to a total weight of the food product (or baking composition)” especially relates to the weight of the food product (or baking composition) comprising water or moisture. In contrast to that, e.g., in “relative to a total dry matter weight (of the food product)” or relative to a “total weight (of the food product) based on the dry matter”, the weight is based on the dry matter, i.e. excluding the water or moisture (in the food product).

Furthermore, when a weight of an ingredient is related to a weight of a further ingredient, the weight is especially based on the dry matter (if the weight does not relate to an aqueous liquid), such as normally is done for nutritional values. Hence the term “weight” in “a total weight of the fiber”, “a total weight of the protein”, “a total weight of the fat”, “a total weight of the stabilizer”, etc., especially relates to the weight based on the dry matter of the ingredient. The fiber, fat, protein, and stabilizer, as such, especially do not comprise moisture.

The term “dry matter weight” is known by the skilled person. The term “dry matter weight” such as in “based on a dry matter weight”, “based on the dry matter”, and “relative to a dry matter weight” relates to a total weight of a (food) product (comprising a determined weight of water) minus the weight of water in the (food) product (the determined weight of water). The dry matter weight of a product is especially equal to a total weight of the product after removing substantially all of the water from the product, such as by heating (over 100° C.) of the product (especially over an extended period of time). Especially, if an amount of a component in a (food) product (or a defined combination of components) is related to the dry matter weight, the dry matter weight of the component is defined relative to the dry matter weight of the (food) product (or the defined combination of components). For instance, where the product comprises at least 30 wt % of protein based on a dry matter weight, a dry matter weight of the protein is especially equal to or more than 30% of a total dry matter weight of the baked food product.

The product, and also the baking composition (see further below), may comprise (a mixture of) different proteins. The product may e.g. comprise egg protein, especially albumin. The product may comprise a milk protein, such as casein and/or whey protein. The product (also) may comprise a vegetable protein, such as one or more vegetable proteins selected from the group consisting of a bean protein, a nut protein, and a seed protein, especially from the group consisting of (a) soy protein, (a) pea protein, and (a) rice protein. The protein may further comprise (an) algae protein or (a) mycoprotein. The food product is especially a gluten-free food product. Essentially, a gluten free food product substantially does not comprise gluten (which is a protein), such as less than 2 wt % of the food product, especially less than 0.5 wt % of the food product, even more especially less than 0.1 wt % of the food product (based on the dry matter weight). In an embodiment, the food product does not comprise gluten. In a further embodiment, the amount of gluten in the food product is about 0.001 wt % of the food product.

Herein a protein may also relate to more than one (different) protein. Especially, the protein comprises albumin. Albumin may provide a good network texture and especially also a minimal off-flavor. The term “albumin” especially relates to egg white.

In embodiments, the protein comprises albumin selected in the range of 20-100 wt % based on a dry matter weight (of a total of the protein(s)), such as selected in the range of 30 wt %- 100 wt %, especially 40 wt %.-100 wt %, even more especially 50 wt %- 100 wt %. In embodiments, at least 50 wt % of the protein (based on the dry matter weight of the total of the protein(s)) consists of albumin. In embodiments, substantially all of the protein is albumin. Hence, in embodiments the baked food product may especially comprise at least 30 wt %, such as at least 40 wt % of albumin based on a dry matter weight (of the baked food product). The product may further comprise a vegetable protein. For instance equal to or less than 50 wt %, such as equal to or less than 40 wt %, especially equal to or less than 30 wt % of the protein may comprise the vegetable protein.

The baked food product further comprises a fiber, especially a dietary fiber. Especially, the dietary fiber comprises one or more of a vegetable fiber and a fruit fiber. The fiber may bind moisture in the baking composition and may provide a baking composition comprising a paste, gel and/or slime. The fiber further may affect the texture of the baked food product. In embodiments, the fiber provides a (dry) bread-like texture and structure.

Hence in embodiments, the dietary fiber comprises a vegetable fiber, especially selected from the group consisting of a flax seed fiber, a hemp fiber, a psyllium fiber, a carrot fiber, an oats fiber, a (red) beet (beet root) fiber, a (broad) bean fiber, and a pumpkin fiber. Additionally or alternatively, the dietary fiber comprises line seed fiber. Additionally or alternatively, the dietary fiber comprises fruit fiber, especially a fruit fiber selected from the group consisting of a citrus fiber, and an apple fiber. A fruit fiber and/or a vegetable fiber may bind water and swell. It may bind e.g. 10-25 gram of water per gram of fiber. The fruit and/or vegetable fiber may swell when being contacted with cold water, and may also be referred to as “a cold-swelling fiber”. Additionally or alternatively, the fiber may comprise a fructan, especially inulin.

Herein, the term “inulin” may also relate to “inulin derivatives” and/or a compound comprising inulin, such as marketed inulin products comprising additional ingredients (next to inulin). Inulin may especially relate to oligosaccharides. Furthermore, the term “inulin” especially relates to an inulin fiber. Examples of inulin derivatives are short-chain oligosaccharides (comprising especially a chain of two to ten monosaccharides) derived from long chain inulin (comprising a chain length of at least ten monosaccharides). A long chain inulin may provide an improved texturizing functionality relative to a short-chain inulin (comprising the short-chain oligosaccharides). A long chain inulin may provide a “longer” texture; it may provide a bread-like texture in the baked food product (compared to a “short”, more brittle, texture as in a shortbread (or biscuit)-like texture). Inulin is especially a texturizer (fiber). Inulin may require shear to provide the texturizing function.

In an embodiment, the dietary fiber comprises one or more of citrus fiber and inulin. In a further embodiment, the dietary fiber is available in an amount of 15-25 wt % based on the dry matter weight of the baked food product. Further, natural plant sources, e.g. comprising a high amount of fiber, may provide the fiber. For instance, chicory, agave, or (wild) yam may be used to provide the (inulin) fiber. Further, embodiments may comprise psyllium seed and/or linseed (also known as flaxseed) providing the fiber (see also below). Herein the term “flaxseed” and “linseed” may be used interchangeably. Hence, in embodiments, the baked food product further comprises flax seed. Hence, the fiber especially comprises a flax seed fiber and/or a psyllium fiber (or husk) and/or a hemp fiber. Especially a husk may provide the fiber.

The (dictary) fiber may comprise a soluble (dictary) fiber and/or an insoluble (dietary) fiber. The ratio of insoluble (dietary) fiber to soluble (dietary) fiber may relate to a functionality of the fiber. The fiber may e.g. provide (give rise to) a firm protein structure (in the baked food product). The fiber further may be used to provide (or define) a desired structure/texture of the food product. The fiber may provide a resilient bread-like structure. (Addition of) A fiber may provide a bread-like texture of the food product, especially wherein the food product without the fiber (or with less fiber) may comprise an egg-like texture. At least 25 wt %, such as at least 35 wt %, especially at least 50 wt % of the dietary fiber (relative to the total weight of the fiber) may comprise an insoluble dietary fiber. In further embodiments, the (weight) fraction of insoluble fiber is equal to or more than 40 wt %, such as equal to or more than 60 wt %, especially equal to or more than 89 wt % relative to the total weight of the (dietary) fiber (especially the total dry weight of the fiber). In yet further embodiments, substantially all dietary fiber consist of (an) insoluble dietary fiber. Yet, in other embodiments, substantially all dietary fiber consists of (a) soluble dietary fiber. Hence, in embodiments, at least 25 wt %, such as at least 35 wt %, especially at least 40 wt %, of the dietary fiber, relative to the total weight of the fiber, comprise (consist of) an insoluble dietary fiber. Insoluble fibers may e.g. be found in whole wheat, corn bran, nuts, seeds, barley, brown rice, bulgur, couscous, zucchini, broccoli, cabbage, onion, tomatoes, root vegetables and green leafy vegetables. Soluble fibers may for example be found in oat bran, oats, flaxseed, nuts, psyllium, lentils, beans, peas, apples, oranges, pears, strawberries, cucumbers, celery, chicory, and carrots.

Some soluble fibers as well as some insoluble fibers may be digested (fermented) by bacteria in the gut. A further division between the fibers may be made based on this difference. The fiber may in embodiments comprise a fermentable fiber (allowing fermentation of the fiber in the large intestine) or the fiber may not or only may partially be fermentable. In specific embodiments, the fiber is fermentable. A fermentable fiber especially comprises a prebiotic fiber and may provide a healthy gut flora. Fructan is an example of a soluble fermentable fiber.

Herein a (dietary) fiber may also relate to more than one (type) of (different) (dietary) fiber. The fiber may comprise a combination of a fiber providing a high water-binding functionality, especially a cold-swelling fiber, and a texturizing fiber. Baking a baking composition comprising substantially only a cold-swelling fiber may provide a compact baked food product. Baking a baking composition comprising substantially only a texturizing fiber may provide a (very) airy and expanded baked food product. In embodiments, (about) 50% of the fiber is a cold-swelling fiber and (about) 50% of the fiber is a texturizing fiber. In further embodiments, this ratio is 60:40, or even 10:90. Especially a ratio of the cold-swelling fiber to the texturizing fiber is selected from the range of 10:90-90:10, such as 25:75-75:25, especially 40:60-60:40 even more especially 45:55-55:45:. In a further embodiment, the product comprises flax seed comprising the fiber.

The food product may comprise a stabilizer. The stabilizer may stabilize or facilitate stabilizing the structure of a matrix of the food product, especially during a process of making the food product (see also below). The term “stabilizer” may also relate to “an improver”. Examples of stabilizers are emulsifiers, crumb softeners, and enzymes. A crumb softener or (bread) improver may comprise a fatty acid (derivative) and/or an emulsifier. A crumb softener or improver may (further) comprise a fat and/or oil. The stabilizer may (further) preserve (the structure of) food product. The stabilizer may e.g. slow down a degeneration process in the product, and/or staling of the food product. In further embodiments, the stabilizer strengthens the matrix during expansion of the product during the production process of the product. Especially, the stabilizer may stabilize a cell structure of the matrix material (the baking composition being baked) during the production of the product, especially during rising. A stabilizer, especially an emulsifier, may provide a homogenous distribution of fat and oil (see below) over the baking composition. For that, the stabilizer, especially the emulsifier may be associated with the fat and/or oil and especially with further elements in the baking composition, such as the fiber and/or the protein. A stabilizer may be selected for its functionality to act on the texture properties of the protein network (in the food product and during the production of the food product). The stabilizer may improve the viscoelastic properties during the production of the food product. The stabilizer may provide an airy food product, especially having a low bulk density. The stabilizer especially comprises an emulsifier. The bulk density for a food product having a volume and a mass of the food product is defined as the ratio of the mass to the volume. The bulk density of a food product is inversely proportional to a specific volume of the food product. Further, the food product may comprise a homogeneous structure (crumb) that may have homogenously distributed (gas) cells (bubbles) (over its structure).

In embodiments, the stabilizer comprises a hydrocolloid. Hydrocolloids are known in the art and may also be called gums. Examples of hydrocolloids are alginate, arabinoxylan, carrageenan, carboxymethylcellulose (CMC), cellulose, gelatin, gellan, (β-) glucan, guar gum, gum Arabic (acacia gum or Arabic gum), locust bean gum (LBG), pectin, and xanthan (gum). Especially, the stabilizer comprises a hydrocolloid selected from the group consisting of guar gum, carrageenan (kappa, iota and/or lambda carrageenan), and xanthan gum. In embodiments, the stabilizer comprises xanthan gum. A stabilizer may relate to more than one (different) stabilizer. When available, the stabilizer may especially be available in the amount of at least 0.1 wt %, such as least than 0.2 wt %, especially at least 0.5 wt % relative to the dry matter weight of the food product. The stabilizer may especially be available in an amount of equal to or less than 7.5 wt %, especially 6 wt %, such as equal to or less than 5 wt %, especially equal to or less than 3 wt %, such as equal to or less than 2 wt % relative to the dry matter weight of the food product. In an embodiment, the stabilizer is available in an amount of 0.5-7.5 wt %, especially 0.5-2 wt % on a dry matter weight of the baked food product.

In further embodiments, the stabilizer comprises one or more stabilizers, especially emulsifiers, selected from the group consisting of lecithin (E322), glycerol (E422), (esters of) mono-and di-glycerides of fatty acids (such as mono-and diglycerides (E471), acetic acid esters of mono-and diglycerides (E472a), lactic acid esters of mono-and diglycerides (E472b), citric acid esters of mono-and diglycerides (E472c), tartaric acid esters of mono-and diglycerides (E472d), diacetyltartaric acid esters of mono-and diglycerides (E472e), and mixed esters of mono-and diglycerides (E472f), sodium or calcium stearoyl lactate (E481, E482), and sorbitan mono stearate (E491). These emulsifiers may be known from normal bread recipes. For instance, glycerol monostearate (or GMS) (E471) is typically applied in normal wheat starch bread to slow down retrogadation of the starch and bind to the amylose fraction of the starch during baking. Herein, E471 may especially relate to GMS. Diacetylated tartaric acid esters of mono-and diglycerides of faty acids (E472e) seem to bind rapidly to hydrated gluten thereby providing a stronger and more resilient gluten network and enhacing gas retention. Sodium stearoyl-2-lactylate (E482) is also capable to bind to amylose like monoglicerides and may provide an extra softness of wheat containing bread. Lecithins (E322), e.g, may be applied to provide a crust that retains its crispness quality longer. Althouhg many of these emulsifiers typically seem to function on, and to associate with, the wheat components in normal (wheat) bread, the inventors surprisingly found that the emulsifiers may also improve the quality of the food product of the invention without added wheat or starch. For making efficient use of the emulsifier and especially associating most of the emulsifier with the fat or oil, the emulsifier may be mixed, especially homogenized in the fat and/or oil before or during the production process of the product.

In a specific embodiment, the stabilizer, especially the emulsifier comprises one or more stabilizers selected from the group consisting of mono-and di-glycerides of fatty acids (E471) and diacetyltartaric acid esters of mono-and diglycerides (E472e). In a further embodiment, the stabilizer, especially the emulsifier, comprises one or more stabilizers (emulsifiers) selected from the group consisting of lecithin (E322), mono-and di-glycerides of fatty acids, especially glycerol monostearate (E471), diacetyltartaric acid esters of mono-and diglycerides (E472e), calcium stearoyl lactate (E482), and sorbitan mono stearate (E491).

The baked food product may further comprise salt. Salt may affect the sensory parameters of the food product. Salt may (also) affect the textural properties of the food product. Especially, salt comprised in a baking composition (see below) may affect a process for baking the food product (scc further below) Especially an amount of salt is selected in the range of 0-4 wt %, like at least 0.1 wt %, such as especially, 0.1-2.5 wt %, relative to a total weight of the baked food product. Yet, in further embodiments, the amount of salt is selected in the range of 0-0.4 wt % relative to a total weight of the baked food product. In embodiments, the amount of salt may be selected in the range of 0-10wt %, such as 0-2 wt %, especially, 0.3-2 wt % relative to a total dry matter weight of the food product. Salt may be provided to the baking composition as table salt or common salt (NaCl). Salt may also be provided as a salt wherein at least part of the sodium is substituted by another positive ion, such as potassium, or wherein sodium chloride is substituted by e.g. magnesium sulfate. Yet in other embodiments, no salt is present, or salt is provided by alternative taste enhancers, such as hydrolyzed vegetable protein (HPV), soy sauce, yeast extracts, a (dried) broth, et cetera. Hence, the food product may also comprise one or more (of these) taste enhancers. It may further be appreciated (by the consumer) that some embodiments of the food product are tough, whereas other embodiments are soft-moist or juicy. In embodiments, the food product may further comprise a lipid, especially (a) fat, even more especially (an) oil. In embodiments, the fat comprises vegetable oil, such as from vegetable seeds and/or nuts. The fat may comprise palm oil, coconut oil, and/or rape oil. The fat may comprise butter and/or (hard) margarine. In further embodiments, the fat comprises olive oil, sunflower oil, soya oil, arachis oil, and/or sesame oil. In embodiments, the oil or fat is hydrogenated. Hence, in an embodiment, the baked food product further comprises (an) oil or (a) fat. In a specific embodiment, the oil or fat comprise one or more of butter, palm oil, coconut oil, and rape oil.

The terms “oil” and “fat” may relate to the same (food) products (comprising fatty acids). The term “oil” may relate to a product that is liquid at room temperature whereas “fat” may relate to (such) a product that is solid, or may not flow at room temperature. Especially, fat and/or oil may provide a juicy food product. In embodiments, the amount of oil or fat may be selected in the range of 0-2 wt % relative to the dry matter weight of the food product. In further embodiments, the amount of fat is equal to or more than 0.1 wt %, such as equal to or more than 0.2 wt %, especially equal to or more than 1 wt %, even more especially equal to or more than 2 wt % based on the dry matter weight. Especially, the amount of fat may be equal to or less than 7.5 wt % based on the dry matter weight of the food product. Hence, in an embodiment, the baked food product (further) comprises oil or fat selected in the range of 0-7.5 wt %, especially 0-2 wt %, based on the dry matter weight. In further embodiments, an amount of oil or fat in the baked food product is equal to or more than 2 wt %, especially equal to or more than 7.5 wt %, more especially equal to or more than 15 wt % on the dry matter weight. Especially, the amount of fat or oil in the food product is equal to or less than 37.5 wt %, especially equal to or less than based 15 wt % on the dry matter weight. Herein the terms “oil” and “fat” may also be used interchangeably. Hence, in embodiments the term “oil or fat” may be replaced by the term “fat”. The terms “fat” and “oil” may relate to a plurality of (different) fats and/or oils. The term may further relate to a mixture of different fats and/or oils. In an embodiment the oil and/or fat are available in an amount of 0.2-7.5 wt % based on the dry matter weight of the baked food product.

The fat or oil may (also) be provided by an (other) ingredient in the food product. For instance, a seed may provide an amount of fat to the baked food product (or baking composition, see also below). In an embodiment, the food product (and/or the baking composition) comprises a vegetable seed, especially comprising (at least a part of) the fat. In an embodiment, a stabilizer, such as a crumb softener may comprise at least part of the fat. The stabilizer may further comprise an emulsifier homogenized in the fat. In further embodiments, the food product comprises a nut, especially comprising (at least a part of) the fat. Natural ingredients such as vegetable seeds and nuts may comprise more than one of the elements of the food product (and baking composition, see below). For instance, flaxseed may comprise a dietary fiber and also fat. Hence, the food product (and the baking composition) may especially comprise a natural product (a seed, a nut, a cheese, a spice, and a herb) comprising the fiber and/or the fat and/or the protein and/or a (digestible) carbohydrate.

The baked food product may further comprise further ingredients. Examples of these further ingredients are (additional) sweetening agents, flavors and taste enhancers. The food product may comprise sweetening agents, like sugar, (inverted) sugar syrup, honey, et cetera. Such sweetening agent may (also) comprise digestible carbohydrates. The sweeting agent may further comprise stevia and/or an artificial sweetener such as sucralose or other sweeteners known to the skilled person. The baking composition may comprise sugars. The baked food product may comprise substantially no sugar. The food product may comprise flavoring agents. Especially a cake analogue, a cookie analogue, or a cracker analogue may comprise one or more further ingredients. In embodiments, the bread-like food product (also) comprises one or more further ingredients. The further ingredients may (also) comprise fat and/or oil.

Especially, the baked food product comprises a bread-like food product, especially having a structure and especially (also) sensory properties like bread. The food product may e.g. have a porosity comparable to a porosity of bread. In embodiments, the porosity of the food product is at least 30 (vol.) %, such as at least 50 (vol.) %, especially at least 60 (vol.) %, even more especially at least 70 (vol.) %. Especially, the porosity may be equal to or smaller than 95 (vol.) %, such as equal to or smaller than 90 (vol.) %. In embodiments, the food product comprises a bread-like product, and the porosity is selected in the range of 50-90 (vol.) %, such as 60-90 (vol.) %. Yet in embodiments of the food product comprising a cookie, the porosity may be selected in the range of 30-60 (vol.) %, especially 50-60 (vol.) %. The term “porosity” relates to the void fraction of the food product, especially a fraction of the volume of voids (gas) over the total volume of the food product. The porosity may especially relate to the crumb of the bread-like food product. In an embodiment, a ratio of a volume of the food product relative to a volume of the baking composition (see below), especially a volume of a total of all ingredients in the baking composition (without a possible gas present) is selected in the range of 2-4. Especially said ratio is selected in the range of 2.5-3.5. The (not yet elevated) food composition comprising a first volume may for instance provide a food product comprising a second volume after processing the baking composition into the food product, and the second volume may e.g. comprise about three times the first volume, such as 2-4 times the first volume, especially 2.5-3.5 times the first volume. In further embodiments, the second volume comprises about 1.1-2 times the first volume, such as 1.1-1.5 times the first volume. The difference between the second volume and the first volume may especially be a volume of gas or void in the food product. The difference may further be the result of a loss of an amount of water during heating of the baking composition in the production of the food product. Said difference may especially relate to the porosity of the food product. The term “processing the baking composition into the food product especially relates to producing the baked food product from the baking composition, especially according to the process described herein (see further below)

For the determination of the porosity of a food product having open pores (such as the products described herein), standard methods, known by the skilled person in the art, are used based on the difference between the bulk density (and/or bulk volume) of the product (the density or volume of the product including the pores) and the intrinsic density of the product, i.e. the density (or volume) of the product without the pores. The bulk density (or volume) may be determined by the (rapeseed) displacement method. The intrinsic density and/or the volume of the pores (or of the product without the pores) may be determined by the gas expansion method using e.g. a Boyle's Law porosimeter.

The food product may further comprise moisture, especially an amount of water. The amount of water (the moisture content) may (also) be selected to mimic a determined type of food product. This does not necessary mean that the moisture content of the food product is in the same range as the moisture content the product it mimics. It was surprisingly found that by replacing starch and gluten protein by one or more other proteins and a fiber, a higher moisture content may advantageously be used to obtain a texture and/or sensory profile comparable to the product it mimics. For instance, a food product comprising a bread-like product may comprise a moisture content selected in the range of 40-75 wt %, such as 50-75 wt %, especially 55-70 wt %. In embodiments, the food product comprising a bread-like product comprises at least 40 wt %, especially at least 45 wt % of water. In further embodiments, the bread-like food product comprises equal to or less than 60 wt %, such as equal to or less than 55 wt % of water. Yet, bread may comprise 35-40 wt % moisture. In embodiments, the food product comprises a moisture content (a water amount) selected in the range of 60-70 wt % (relative to the total weight of the baked food product). Especially, moisture (content) relates to a liquid, especially water (including water in an aqueous liquid).

In further embodiments, the (mean) moisture content (in the food product) may be at least 25 wt %, such as at least 30 wt %, even more especially at least 35 wt % (all relative to the total weight of the food product). The (mean) moisture content may in embodiments be equal to or smaller than 60 wt % (relative to the total weight of the food product), such as smaller than or equal to 50 wt %, especially smaller than or equal to 40 wt %.

In an embodiment, especially comprising a bread-like product, the moisture content is selected in the range of 55-70 wt %, especially in the range of 60-70 wt %, relative to a total weight of the baked food product. Yet in another embodiment comprising a bread-like product, the moisture content is selected from the range of 40-60 wt %, especially 45-55 wt %, relative to a total weight of the baked food product. Yet, in further embodiments of the food product, the moisture content is selected in the range of 10-30 wt %. For products comprising a (relatively dry) crust and a relatively moist crumb or core, the moisture content may vary over the products. Hence, herein the moisture content especially relates to the mean moisture content. The mean content and mean percentages herein, especially relate to a volume average content or a volume average percentage. The mean values may further, relate to a weight average value.

The bread-like product may further comprise a cell structure that resembles the cell structure of bread. For instance, an average cell diameter of the crumb of the bread-like product (bread analogue) relative to an average cell diameter of a (normal) bread is selected in the range of 0.2-2, especially 0.5-1.125. The average cell diameter may especially be in the range of 0.1 mm-8 mm, such as 0.1 mm-4 mm, especially 0.2-2 mm. The bread analogue may also comprise one or more cells having a cell diameter of about 1.5 cm. In an embodiment, at least 90% of the number of cells comprises a cell diameter in the range of 0.1-1 mm. In another embodiment, at least 90% of the number of cells comprises a cell diameter in the range of 1-3 mm. For a bread-like product, the average cell diameter may be equal to or larger than 1 mm, such as equal to or larger than 2 mm, and especially equal to and smaller than 5 mm, such as equal to and smaller than 4 mm. In a further embodiment, the average cell diameter is selected from the range of 1.5-3 mm.

Additionally or alternatively, a number of (gas) cells per cm² (of a slice) of the food product (a bread analogue) relative to a number of (gas) cells per cm² of a (slice of) bread may be in the range of 0.25-4, especially 0.5-2. In further embodiments, the number of (gas) cells per cm² is selected from the range of 50-150, especially from the range of 50-100. Also an average width of a cell wall (of the (gas) cell in the food product) may be comparable to the ones in (normal) bread comprising (wheat) starch and gluten, especially a (normal) white bread (see further below). The average width of the cell wall may e.g. be smaller than or equal to 0.7 mm, especially smaller than or equal to 0.6 mm. The average width of the cell wall is especially at least 0.3 mm, such as at least 0.4 mm. Additionally or alternatively, an average cell volume of (gas) cells of the food product (the bread analogue) relative to an average cell volume of (gas) cells of a bread may be in the range of 0.25-4, especially 0.5-2. In embodiments, the average cell volume (of the gas cell in the food product) is at least 4.5 mm³. The average cell volume may especially be equal to or smaller than 15, such as 10 mm³. The average cell volume may e.g. be selected from the range of 4-8, such as 5-8 mm³, especially 5-7 mm³. Also, an (average) clongation of the cells of the food product may be comparable to the ones of a bread. The average elongation of the cells may, e.g., be equal to or smaller than 2, such as equal to and smaller than 1.8. The average elongation is especially at least 1, such as at least 1.4. In embodiments, the average elongation of the cells of the food product is selected from the range of 1.3-1.8, such as 1.4-1.7, especially 1.5-1.7. Additionally and alternatively, a total area of the (gas) cells relative to a total area of a slice of the food product (also indicated as a ratio of cells per slice area or the cell-total area ratio) may be 50%- 200%, especially 75-125% of a total area of (gas) cells relative to a total area of a slice of bread. The (ratio of the) total area of the cells relative to the total slice area (of a slice of the food product) may e.g. be selected from the range of 40-60%, such as 45-55%, especially 48-52% (of the total area of the slice of the food product). Hence, in an embodiment the baked food product comprises a bread-like food product, wherein a total area of (gas) cells relative to a total slice area of a slice of the food product (as determined with a C-Cell analysis) is selected from the range of 40-60%, especially from the range of 45-55%, such as from the range of 48-52%.

The terms “number of (gas) cells”, “cell diameter”, “cell wall thickness”, “elongation”, “cell volume”, and the “cell area” are known to the person skilled in the art and are e.g. further described by the American Association of Cereal Chemist in method 10-18.01. The values may be determined with a C-Cell (apparatus/analysis) as is described in the method AACCI 10-18.01, see also the section “further experiments” at the end of the description. For the measurement a slice of the product is analyzed with the C-Cell. Especially, a cut surface of the slice at is analyzed. Hence, the term “slice area” relates to a total area of the (cut) surface of the slice, especially comprising the crumb (and excluding the crust). Moreover, the ratio of cells per slice area may relate to a specific volume of the product. Especially, the ratios of cells per slice area may (directly correlate with the porosity of the product. Hence comparing the porosity of the food product with the porosity of a product it may mimic, such as bread, may relate to comparing the ratio of cells per slice area of the food product with the ratio of cells per slice of the product it may mimic.

The (gas) cells, especially the (average) cell diameter, the number of cells, the cell wall thickness, the average cell volume, and the cell area may be controlled by a process for the production of the baked food product from a baking composition (see also below). For instance, the (mean) cell diameter and/or other cell dimensions may be controlled by a leavening agent used in the baking composition or a proofing period (see also below).”

The (average) cell diameter may especially be selected as a function of a process condition of the process for the production of a baked food product (see below).

The average cell diameter relates to an equivalent diameter. The average cell diameter may further be calculated from a mean (surface) area per cell, wherein the mean area per cell may be defined as a total area of cells in a slice of the food product divided by a total number of cells in the slice. Especially, the average cell diameter equals 2*(said mean area per cell/π)^{1/2}.

Herein, the term “(gas) cells” especially relates to a crumb cell.

The bread-like product may (also) have a hardness or compressibility of the crust and/or the crumb, and/or a resilience or relaxation (springiness) of the crumb (and/or the crust) being comparable to respectively a hardness of a crust and/or the crumb, and/or a resilience or relaxation of the crumb of a bread (when measured within 24 hours after production). Hence, a hardness of the crust and/or the hardness/compressibility of the crumb (e.g. measured in N or gram force) of the bread-like food product relative to a hardness of the crust and/or the crumb of a bread may be in the range 0.5-2, especially 0.8-1.125. In embodiments, the hardness of the crust of the bread-like product is less than the hardness of the crust of a bread. In embodiments, the hardness of the crust of the bread-like food product relative to the hardness of a crust of a bread is less than or equal to 0.9, and especially at least 0.1, such as at least 0.25. In embodiments, the hardness (or compressibility) of the crumb of the bread-like product is more than the hardness of the crumb of a bread. In embodiments, the hardness (compressibility) of the crumb of the bread-like food product (as measured by a texture analyzer in gram force, see also below in the experimental section) relative to the hardness of a crumb of a bread is at least 0.75, such as at least 1, especially at least 1.5, and especially equal to or smaller than 3 Also, a resilience or relaxation percentage of the crumb (and/or the crust) (e.g. determined by a rheometer or a texture analyzer) of the bread-like food product relative to a resilience or relaxation percentage of the crumb (and/or the crust) of a bread may be in the range of 0.5-2, especially 0.8-1.125. In embodiments, the resilience or relaxation percentage of the crust of the bread-like food product relative to a resilience of the crust of a bread may be in the range of 0.5-0.8. Herein, the properties of “a bread”, such as in the phrase “resilience of bread” “an average cell diameter of a bread”, etc., especially relate to a value for an average type of bread, especially a Dutch type of bread, such as a whole grain bread or a wheat bread of the type “vloerbrood”, “busbrood”, “casinobrood”, “plaatbrood”, scc also the breads described in the section “further experiments”. The textural properties such as hardness, resilience, relaxation, etc. are especially determined within 24 hours after production, see also the section “further experiments” explaining the determination in more detail. The products, especially the commercial breads may deteriorate quickly, hence measurements after two or three days after production may show completely different values for the textural parameters. The difference between the commercial (especially wheat starch containing) breads and the bread-like products may increase during these days, especially because the bread-like products may not deteriorate that quickly, and the textural properties of the bread-like products of the invention may not changes that much in the days after production. This may be duc because especially the starchy matrix of the commercial breads (that is not present in the food product of the invention) may be subject to retrogadation.

In a further aspect, the invention provides a process for the production of a baked food product, especially the baked food described herein. The process comprises heating a baking composition (“composition”) comprising a fiber, a protein, water, and especially an optional leavening agent and/or an optional stabilizer, and optionally further ingredients, to provide the food product. The baking composition essentially comprises a higher amount of water than the food product (when heated, especially baked). In embodiments, the baking composition comprises a water amount of at least 40 wt % relative to a total weight of the baking composition. Especially, the water amount is at least 50 wt %, especially at least 55 wt %, such as at least 60 wt %, relative to the weight of the composition. In further embodiments, the water amount (in the composition) is lower than or equal to 75 wt %, especially lower than or equal to 72.5 wt %, even more especially lower than or equal to 70 wt % (relative to the total weight of the composition) In embodiments, the water amount is selected in the range of 60-75 wt %, such as 60-72.5 wt % relative to the total weight of the baking composition. In other embodiments, the water amount is selected in the range of 50-70 wt %, especially 55-70 wt %, especially 57-68 wt %, such as 58-67 wt % relative to the total weight of the baking composition.

The baking composition (and hence also the process), especially, comprises a protein as described herein. In embodiments, a protein amount is at least 10 wt %, such as at least 12.5 wt %, especially at least 15 wt % relative to the total weight of the composition. In embodiments, the protein amount is less than or equal to 35 wt %, especially less than or equal to 30 wt %, such as equal to or less than 25 wt % or equal to or less than 20 wt % relative to the total weight of the composition. Especially, the protein amount is selected in the range of 12-22.5 wt %, especially 12-20 wt % relative to the total weight (including the moisture) of the composition. In embodiments, a protein comprising powder (“protein powder”) may be provided to the baking composition, especially to provide the protein. The protein comprising powder may e.g. comprise a protein isolate or a protein concentrate. The protein comprising powder especially comprises at least part of the protein. Additionally, the protein comprising powder may comprise further elements, such as filler material, carbohydrates, fats, anti-caking agents, minerals, vitamins, “ash”, et cetera. In embodiments, the baking composition comprises 0-15 wt %, such as 0-7.5 wt % fat.

The baking composition may relate to a batter. In other embodiments, the baking composition relates to a dough. Especially, the baking composition comprises a batter.

The baking composition further especially comprises a fiber as described herein. In an embodiment, a fiber amount (in the baking composition) is at least 4 wt %, such as at least 5 wt %, especially at least 7.5 wt % relative to the total weight of the composition (including the moisture). In a further embodiment, the fiber amount (in the composition) is less than or equal to 25 wt %, especially less than or equal to 20 wt %, such as equal to or less than 17.5 wt % or equal to or less than 16 wt % relative to the total weight of the composition. Especially, the fiber amount (in the composition) is selected in the range of 5-20 wt %, especially 5-17.5 wt %, such as 5-16 wt % relative to a total weight of the baking composition. In a further embodiment, the fiber amount is selected form the range of 7.5-20 wt %, especially 7.5-15 wt %, such as 8-12 wt %, relative to the total weight of the baking composition.

Herein, a fiber may also relate to more than one (different) fiber. Especially, the fiber comprises a dietary fiber. In an embodiment, the baking composition comprises a flax seed (comprising the fiber and optionally a lipid). In further embodiments, the baking composition comprises a flax seed amount selected in the range of 0.01-5 wt %, such as 0.01-4 wt %, especially 0.01-2.5 wt % relative to the total weight of the baking composition. Herein flax seed may also relate to flax seed flower or ground flax seed. In further embodiments, the baking composition comprises a citrus fiber. Especially, the baking composition comprises a citrus fiber amount selected in the range of 0-15 wt %, such as 0-10 wt %, especially 5-10 wt % relative to the total weight of the baking composition. In yet further embodiments the baking composition may comprise inulin. Especially, the baking composition comprises an inulin amount selected in the range of 0-15 wt %, such as 0-10 wt %, especially 5-10 wt % relative to the total weight of the baking composition.

The baking composition may further comprise a leavening agent. Leavening agents are known in the art and may also be called “raising agents” and may raise the baking composition in time and or at an elevated temperature, especially because of the formation of a gas, especially carbon dioxide and/or occasionally hydrogen or another gas. The leavening agent may e.g. comprise a (dried or fresh) baker's yeast (“yeast”), a baking powder, baking soda, or e.g. a combination of an acid and a salt of bicarbonate. The (fresh) yeast may be provided by a liquid yeast. A liquid yeast is especially a combination of yeast and a liquid, especially water. The liquid yeast may e.g. comprise about 80 wt % water and 20 wt % yeast. Additionally or alternatively, a gas may directly be provided to the baking composition (see further below). Hence, the baking composition does not necessarily comprise a leavening agent. In further embodiments, the baking composition does not comprise a leavening agent. Herein, the term “leavening agent” may also relate to more than one (different) leavening agent.

In embodiments, the optional leavening agent comprises one or more leavening agents selected form the group consisting of (bakers') yeast, baking soda, and baking powder. Hence, the (optional) leavening agent comprises a leavening agent selected from the group of yeast, baking powder, and baking soda.

In the composition, the leavening agent may comprise a leavening agent amount. The leavening agent amount may be selected based on the type of leavening agent. Baking powder may for instance comprise filler material that may not provide a gas. Baking powder may (at higher amounts) provide an off-flavor to the food product. A (specific) yeast may provide less gas relative to other yeasts and/or to a (specific) baking agents. Also, when using a fresh yeast, the composition may comprise a higher amount of yeast compared to a composition comprising a dry yeast or an instant yeast. Especially, in the baking composition an amount of a baking powder may be equal to or less than 15 wt %, such as equal to and less than 10 wt % relative to the total weight of the baking composition. In further embodiments, the amount of baking powder in the baking composition is selected the range of 0-5 wt %, especially in the range of 0-2.5 wt %, relative to the total weight of the baking composition. In an embodiment of the baking composition, an amount of yeast is equal to or less than 15 wt %, such as equal to or less than 10 wt %, such as equal to or less than 5 wt %. In yet further embodiments, the amount of yeast, especially dry yeast or instant yeast, is equal to or less than 3 wt %. In another embodiment comprising a liquid yeast, the amount of yeast is selected from the range of 5-15 wt % (relative to the total weight of the composition). In the baking composition an amount of a baking soda may be equal to or less than 20 wt %, such as equal to and less than 10 wt % relative to the total weight of the baking composition. In an embodiment of the baking composition, an amount of baking soda is equal to or less than 5 wt %, relative to the total weight of the baking composition. Especially, the amount of leavening agent comprises a concentration selected in the range of equal to or less than 30 wt %, such as in the range of 0-20 wt %, especially in the range of 0-15 wt %, even more especially in the range of 0-10 wt %, such as equal to or less than 10 wt %, especially equal to or less than 5 wt % relative to a total weight of the baking composition. The amount of leavening agent may not be technically limiting. In embodiments, an increased amount of leavening agent, such as equal to 20 wt % (relative to the total weight of the baking composition) may provide an off-flavor to the baked food product. In further embodiments, a leavening agent concentration larger than 15 wt % may provide an off-flavor to the baked food product.

The optional leavening agent may comprise (a) yeast. The leavening agent may further comprise baking soda. Yet in further embodiments, the leavening agent comprises baking powder. Hence, the baking composition may comprise an amount of baking powder. Especially, the amount of baking powder may be equal to or less than 15 wt % relative to the total weight of the baking composition, especially equal to or less than 10 wt %. A leavening agent (the optional leavening agent) may also comprise more than one (different) leavening agent. The yeast may be provided by a liquid yeast. Hence, the baking composition may comprise a liquid yeast.

The leavening agent, especially yeast, may require “feed material”, such as a sugar, for the leavening agent to provide a gas (to convert the feed material into the gas). Hence, the baking composition may comprise sugar. The amount of sugar may not be functionally limiting. In embodiments, the amount of sugar is selected from the range of 0-25 wt % relative to the total weight of the baking composition. The amount of sugar may especially be selected equal to or smaller than 15 wt %, especially equal to or smaller than 7.5 wt %, relative to the total weight of the baking composition. Especially, the amount of sugar may be selected to be completely used by the leavening agent during proofing. Especially, the baking composition may comprise an amount of sugar selected from the range of 1-10 wt %, such as 2-8 wt %, especially 3-6 wt % relative to the total weight of the baking composition. In embodiments, the amount of sugar is selected to be equal to or less than 3 wt %, and especially at least 1 wt % (relative to the total weight of the baking composition). Especially, substantially no sugar is left in the baked food product. At least part of the sugar may thus comprise and/or act as a processing aid (especially being consumed during processing, and not being part of the food product). In a further embodiment, the baking composition substantially does not comprise sugar. The term “sugar” may especially relate to “added sugar”, especially a disaccharide and/or a monosaccharide, especially “sucrose”. In embodiments, the (added) sugar comprises one or more of sucrose, dextrose (glucose), fructose, and galactose. The sugar may be selected based on the yeast in the baking composition (and vice versa).

Additionally, the baking composition may comprise a stabilizer, especially as described above. A stabilizer amount in the baking composition may be selected in the range of 0.01-2 wt %, especially in the range of 0.4-1.2 wt % relative to the total weight of the baking composition. In a further embodiment, the baking composition does not comprise a stabilizer. Especially the stabilizer amount is equal to or less than 2 wt %, such as equal to or less than 1.2 wt % relative to the total weight of the baking composition. Yet, in further embodiments, the stabilizer may be equal to or smaller than 5 wt %, such as equal to or smaller than 3 wt %, or equal to or smaller than 2.5 wt %. The stabilizer amount may be at least 0.01 wt % relative to the total weight of the baking composition. The stabilizer amount may be selected in the range of 0.01-3 wt % relative to the total weight of the baking composition. The stabilizer may be homogenized in the fat and or oil before or during the process. Hence, the process may comprise homogenization of the stabilizer in the fat or oil.

Hence, in embodiments, the baking composition comprises a water amount selected in the range of 50-72.5 wt %, a protein amount selected in the range of 12-20 wt %, a fiber amount selected in the range of 5-16 wt %, a leavening agent amount selected in the range of 0-10 wt %, and a stabilizer amount selected in the range of 0.01-3 wt %, relative to a total weight of the baking composition. The baking composition may further comprise (optional) further ingredients. Examples of further ingredients are described before and may (also) comprise e.g. a flavor, cheese, spices, fat, oil, a nut, a seed, a herb, a dairy product, a juice, et cetera.

The baking composition further comprises water. Water may directly be provided to the baking composition. Additionally or alternatively, the baking composition may comprise a (aqueous) liquid or another ingredient comprising at least part of the water. In embodiments, the baking composition comprises a dairy product, e.g. milk, whey, cream (sour cream, crème fraiche, etc.), curd, (fresh) cheese, yoghurt, etc., comprising water. In further embodiments, the baking composition comprises a fruit juice, a vegetable juice, a fermentation juice (comprising water). In further embodiments the baking composition comprises (an extract of) a fruit and/or a vegetable comprising water. The baking composition may further comprise a protein comprising water, and/or a protein drink such as nut milk, soy milk, rice milk, protein shake, etc. Hence, water in the baking composition may be provided by different elements in the baking composition and especially does not need to be provided as pure water. Especially, a solution comprising water may be provided to the baking solution (to provide the water). Herein the term “solution” may relate to a combination of one or more elements with water. The elements not necessarily have to be dissolved or suspended in the water. The term “solution” may also relate to pure water.

Essentially, the elements in the (baked) food product may substantially all be comprised in the baking composition. Hence, the backing composition may comprise especially all ingredients described above, in relation with the baked food product. A leavening agent may not be present in the food product (or the food product may only comprise traces of the leavening agent), especially because a leavening agent may be converted during the process for the production of the food product. Also at least a part of the sugar may be converted during the process for the production of the food product (see above). Further, the amount of water in the food product may be lower than the amount of water in the baking composition.

It is noted that percentages such as weight percentages described herein may relate to a total dry weight of a product (the food product or e.g. a baking composition). The percentages may further relate to a total weight of a product (hence including any moisture). In the following table, some amounts of compounds/elements in the baking composition and/or the food product are depicted for specific embodiments of the invention, including upper and lower limits of example embodiments. The table depicts an overview for a range of embodiments. Further embodiments may have other upper and lower composition limits, see e.g. compositions depicted in the experimental section. In embodiments, the amount of water in the baking composition may e.g. be reduced to about 55-70 wt %, especially 57-68 wt % (thereby increasing the wt % of the other compounds proportionally).

In the table, the percentage water in the baking composition relates to water added in liquid form, the added water. The weight percentages of other ingredients (especially the fiber, the protein) may include water present or small amounts of other elements present in these ingredients. The water percentages in the product relate directly to the amount of water present in the food product.

| | Wt % in the | Wt % in the food product | |
|---|---|---|---|
| | baking composition | Relative to | Relative to the |
| | Relative to the | the total | total dry |
| Compound/ | total weight of | weight of | matter weight |
| element | the composition | the product | (of the product) |
| Water | 60-75 | 45-60 | |
| Protein | 12-22.5 | 15-28.5 | 40-85 |
| Fiber | 5-17.5 | 6-22 | 15-65 |
| soluble fiber | 3-10.5 | 3.5-13.5 | 10-40 |
| insoluble fiber | 2-8 | 2.5-10 | 5-30 |
| Stabilizer | 0-1.2 | 0-2 | 0-6 |
| Salt | 0-0.4 | 0-0.5 | 0-1.5 |
| Leavening agent | 0-10 | 0-12.5 | 0-37.5 |
| Fat | 1-10 | 1-12.5 | 2.5-37.5 |
| Digestible | 0-5 | 0-6.5 | 0-20 |
| Carbohydrates | | | |

The process may comprise a mixing stage and a (sequential) baking stage. Especially in the mixing stage, the fiber, the protein, water, the stabilizer, and optionally the optional leavening agent and the optional further ingredients are mixed to provide the baking composition. The baking stage especially comprises heating the baking composition. The optional further ingredients may comprise fat (and/or oil). In an embodiment, the amount of fat in the baking composition is selected from the range of 1-10 wt %, especially 1-6 wt %, even more especially 1-5 wt %, relative to a total weight of the baking composition. If the optional further ingredient comprise a fat and/or oil, it may be advantageous to homogenize the stabilizer in the fat or oil (before or during the mixing stage).

The process may comprise (sequentially) a pre-mixing stage, a further mixing stage, a protein mixing stage, and a baking stage. The mixing stage may comprise the premixing stage, the further mixing stage and the protein mixing stage. The process may further comprise proofing the baking composition (especially in a proofing stage) before baking the composition. The proofing stage is especially configured before heating the baking composition. The proofing stage may be configured after the protein mixing stage and before the baking stage. The proofing stage may be configured between the mixing stage and the baking stage.

Especially, the pre-mixing stage comprises mixing a first fiber, and optionally first further ingredients to provide a dry premix. Mixing dry ingredients in the pre-mixing stage may provide a homogeneous mixture (premix). The pre-mixing stage may prevent a formation of aggregates. Especially, the optional further ingredients comprise the optional first further ingredients.

Especially, the further mixing stage comprises: mixing the dry premix with a solution comprising the water and optionally a second fiber and optional second further ingredients to provide a liquid mixture. In the further mixing stage, the fibers may be hydrated. Especially a viscosity of the (liquid) mixture may increase during mixing in the further mixing stage. Especially, during mixing, energy is supplied to the (liquid) mixture allowing to hydrate the fibers. Especially, the optional further ingredients (also) comprise the optional second further ingredients. The optional further ingredients may comprise optional first further ingredients and/or optional second further ingredients.

The protein mixing stage especially comprises: providing a protein comprising powder, comprising the protein, to the liquid mixture and mixing the protein comprising powder with the liquid mixture to provide the baking composition (to be baked).

Mixing may be less vigorously in the protein mixing stage compared to the further mixing stage to preserve functional properties of the protein. Yet, the protein mixing stage may further (also) comprise whisking to provide an incorporation of air in the baking composition. In embodiments, mixing is provided by a Hobart mixer, especially in the protein mixing stage, and especially (also) in the further mixing stage. In embodiments, mixing is provided by the Hobart mixer using a whisk mixer attachment, and especially applying the highest mixing setting (relatively providing the highest energy input). The protein mixing stage may provide a baking composition comprising an airy batter, especially a protein foam. The optional proofing stage (see below) may provide a (first) rise (pre-risc) to the baking composition (to provide a leavened baking composition).

In further embodiments of the process, the mixing stage comprises:
mixing dry ingredients to provide a dry mixture, wherein the dry ingredients are the ingredients selected from the group comprising the fiber, the protein, the stabilizer, the optional leavening agent, and the optional further ingredients, wherein the ingredient comprises at least 90 wt % dry matter relative to a total weight of the ingredient;
mixing wet ingredients in the dry mixture into a smooth batter, wherein the wet ingredients are the ingredients selected from the group comprising water, the fiber, the protein, the stabilizer, the optional leavening agent, and the optional further ingredients, wherein the ingredient comprise less than 90 wt % dry matter relative to the total weight of the ingredient.

The baking stage comprises heating the (optionally leavened) baking composition to provide the food product. Embodiments of the process may comprise a proofing stage, especially wherein the baking composition may rest, and especially may rise, before it is baked in the baking stage. Hence, in further embodiments, the method further comprises a proofing stage, wherein the baking composition (to be baked) is proofed during a proofing period, wherein the proofing stage is configured before heating the baking composition, especially after the protein mixing stage and before the baking stage.

The baking composition, especially comprising a leavening agent, may pre-rise during the proofing stage. The proofing stage may comprise providing a relative humidity selected in the range of 70-95% RH, especially 80-90% RH to the baking composition, and especially providing a temperature selected in the range of 5-65° C., especially 10-45° C. such as 25-35° C. The proofing stage may comprise a proofing period equal to or more than 15 minutes, especially equal to or more than 20 minutes, such as selected in the range of 20 min-240 min, especially 30 min-180 min. In embodiments, the proofing period may comprise at least 2 hours, such as at least 4 hours. In further embodiments, the proofing period comprises equal to or less than 24 hours. The proofing stage may provide a leavened baking composition (after the proofing period).

The pre-mixing stage especially comprises mixing dry ingredient to provide a dry premix. Especially, the first fiber comprises a dry fiber, and especially the optional first further ingredients comprise dry further ingredients. Especially, liquid ingredients and/or ingredients mixed with a liquid, may be provided in the further mixing stage and/or the protein mixing. In embodiments, the first fiber comprises a citrus fiber. In further embodiments, the optional second fiber comprises inulin (and/or an inulin derivative).

In embodiments wherein the baking composition comprises the stabilizer, at least one of the optional first further ingredients and the optional second further ingredients comprises the stabilizer. In further embodiments, at least one of the optional first further ingredients and the optional second further ingredients (also) comprises sugar, especially wherein the baking composition comprises yeast. The sugar in the baking composition may be used, especially converted in gas, in the proofing stage. Especially after the proofing stage and before baking the composition, the baking composition may substantially not comprise sugar.

The (optional) leavening agent may be provided at different stages of the process. The optional leavening agent, especially comprising a dry leavening agent, may be provided in the pre-mixing stage. The leavening agent may be provided in the further mixing stage. Yet, in further embodiments, the leavening agent may be provided in the protein mixing stage. In embodiments the (same) leavening agent(s) is (are) provided in several stages of the process. In further embodiments, different leavening agents are provided at different stages. In yet further embodiments different leavening agents are provided at the same stage. Especially, the optional leavening agent may be provided in combination with a sugar (see above).

Hence, the optional first further ingredients and/or the optional second further ingredients may comprise an optional leavening agent. Additionally or alternatively, the protein mixing stage further comprises providing the optional leavening agent to the liquid mixture and mixing the leavening agent with the liquid mixture. In further embodiments, a gas is provided before the baking stage, especially in the protein mixing stage, especially to (further) expand the baking composition. Hence, the protein mixing stage further may comprisc providing a gas to the liquid mixture. In embodiments, (only) gas is provided to the baking composition. A gas may be provided by injecting the gas, especially under pressure, in the (liquid) mixture, especially the mixture of the protein comprising powder and the liquid mixture (in the protein mixing stage). In other embodiments (only) leavening agent is provided to the baking composition (to the mixture) in one or more of the stages of the process. In other embodiments a leavening agent is provided and a gas is provided to the (baking) composition (or mixture), especially before the baking stage. The gas may comprise any gascous material. In advantageous embodiments, the gas is selected from the group of gasses consisting of carbon dioxide, nitrogen, water vapor, steam, air. The gas may comprise an atmospheric pressure (when being provided to the composition). The gas may further comprise a pressure over 1 bar (absolute). In embodiments, the gas comprises a pressure selected in the range of 1-10 bar (absolutc), especially 1-5 bar (absolute).

Hence, in an embodiment, the process comprises a pre-mixing stage, a further mixing stage, a protein mixing stage, (optionally a proofing stage,) and a baking stage, wherein at least one of the optional first further ingredients and the optional second further ingredients comprises the stabilizer (and wherein the baking composition comprises said stabilizer), especially wherein (a) the optional first further ingredients and/or the optional second further ingredients comprise the optional leavening agent and especially (also) sugar, and/or wherein the protein mixing stage further comprises providing the optional leavening agent to the liquid mixture and mixing the leavening agent with the liquid mixture and/or (b) the protein mixing stage further comprises providing a gas to the liquid mixture. In embodiments, the protein mixing stage further comprises providing the optional leavening agent to the liquid mixture and (further) mixing the leavening agent (and the protein comprising powder) with the liquid mixture (to provide the baking composition to be baked). In further embodiments, the protein mixing stage further comprises providing sugar to the liquid mixture and (further) mixing the sugar with the liquid mixture.

Especially, the optional leavening agent may be provided (and mixed with the respective mixtures) in one or more of the pre-mixing stage, the further mixing stage and the protein mixing stage. Also a sugar may be may be provided (and mixed with the respective mixtures) in one or more of the pre-mixing stage, the further mixing stage and the protein mixing stage. Alternatively, the optional leavening agent (comprising a dry or solid agent) is provided in the initial mixing stage and/or the optional leavening agent (comprising a flowable or liquid agent) is provided in the final mixing stage.

Especially, the process comprises the proofing stage. Especially, an amount of sugar in the baking composition reduces in the proofing stage, especially to substantially zero. In further embodiments, the amount of sugar in the baking composition reduces in the proofing stage to an amount equal to or less than 2 wt % (related to the weight of the baking composition)

The baking stage comprises heating the baking composition. Heating may fixate the baking composition. Heating may further provide a (further) rise of the baking composition (before fixating). Heating may be provided by radiation, convection or conduction. In embodiments, heating is provided in a baking oven. In further embodiments, heating may (also) be provided (by micro waves) in a microwave oven. Yet in further embodiments, heating may (further) be provided by Radio Frequent (RF) heating and/or Ohmic heating. In embodiments, different ways described above to provide heating may be combined. Heating is especially provided at a (heating) temperature of at least 100° C., especially at least 120° C. Heating may further be provided at a (heating) temperature equal to or lower than 300° C., such as equal to or less than 290° C., especially equal to or less than 260° C. Especially, the baking stage comprises heating the baking composition at a (heating) temperature selected in the range of 120° C.-290° C., such as 120° C.-240° C. Heating may be provided during a (baking) period, especially selected in the range of 20 min-120 min, such as in the range of 30-90 min, especially 30-60 min. In embodiments, the baking period is selected to be equal to or less than 30 min, such as selected in the range of 5-30 min, especially 10-25 min. such as 10-20 min. In further embodiments, the baking period is equal to or more than 30 minutes, such as equal to or more than 60 min. In embodiments, the baking period is more than 2 hours.

The baking period is especially selected from the range of 5-120 minutes. Small products, such as a bun or a roll, may e.g. require a short baking (5-10 min) period and a high baking temperature of e.g. 240-290° C. Larger products such as a loaf of bread may require a longer baking period in combination with a lower heating temperature In embodiments, heating is provided a temperature equal to or higher than 140° C., especially equal to or higher than 160° C. In further embodiments, heating is provided at a temperature equal to or lower than 220° C., especially equal to or lower than 200° C. In specific embodiments, the baking stage comprises heating the baking composition at a temperature selected in the range of 120°-290° C. during a baking period selected in the range of 5 min-120 min.

The baking period and the heating temperature may be selected in relation with a volume of the baking composition (to be baked). The baking period may further be selected based on a way the heat is provided (a classic heating in a baking oven or e.g. a volumetric heating process like heating in a microwave, heating by RF heating or heating by Ohmic heating). The heating period when heated in a baking oven may be selected larger than the heating period using a volumetric heating process)

In further embodiments, the baking stage (further) comprises providing a (partial) vacuum to the (baked) baking composition. Providing a vacuum may improve a (loaf) volume of the (baked) food product. Providing the vacuum may (be configured to) cool the baked baking composition, and may especially be referred to as vacuum cooling. The vacuum is especially configured for cooling the baked baking composition, especially a core of the baked baking composition to a core temperature selected from the range of 30-50° C., such as 35-45° C., especially 35-40° C. The vacuum may be e.g. be provided for a period selected from the range of 1-10 minutes, especially 4-8 minutes, such as 5-6 minutes. The vacuum provided to the baking composition may comprise a (absolute) pressure selected from the range of 10 mbar-500 mbar, especially 50 mbar-200 mbar (absolute). The pressure provided during the vacuum is especially at least 50 mbar (absolute), such as 70 mbar (absolute). The pressure is especially equal to or less than 250 mbar (absolute), such as 150 mbar (absolute), especially 100 mbar (absolute). Essentially, he pressure and the period are may relate to a size of the food product. A food product having a large size may require a longer period and/or lower pressure to cool relative to a smaller product. Hence, in embodiments the pressure and/or the period may differ from the ranges given above. Essentially, the pressure and the period are selected to provide the core temperature of the food product in the range of 30-50° C., such as 35-45° C., especially 35-40° C.

Hence, in an embodiment, the baking stage after heating the baking composition during the baking period further comprises: providing a vacuum to the baked baking composition, wherein the vacuum is configured for cooling a core of the baking composition to a core temperature selected from the range of 35-40° C.

In an embodiment, an airy batter or protein foam is provided by mixing (in the protein mixing stage). Successively the protein foam (comprising encapsulated gas) may be fixated during baking.

In a further aspect, the invention provides a baking composition obtainable by the processes described herein, especially the baking composition described herein. The bread as provided, according to embodiments of the invention, may have one or more of a number of cells (per area size), cell diameter, cell wall thickness, cell elongation, cell volume, ratio of the cell area relative to the slice area (%), brightness of the slice, etc. within the same ranges as breads defined according to the UK Bread and Flour Regulations 1998 (into force 19 Feb. 1998; http://www.legislation.gov.uk/uksi/1998/141/made). This regulation defines “bread” as a food of any size, shape or form, which: (a) is usually known as bread, and (b) consists of a dough made from flour and water, with or without other ingredients, which has been fermented by yeast or otherwise leavened and subsequently baked or partly baked, but does not include buns, bunloaves, chapatis, chollas, pitta bread, potato bread or bread specially prepared for coeliac sufferers. Herein, for the sake of comparison, it is especially referred to the subsequently baked product under this regulation. Hence, one or more organoleptic properties, especially sight, or touch, texture, and structure, may be within the same ranges as breads defined according the afore-mentioned regulation.

The term “substantially” herein, such as in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms “first”, “second”, “third” and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to an advantage.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Furthermore, some of the features can form the basis for one or more divisional applications.

### EXPERIMENTAL

### Initial Set of Experiments

Bread-like products have been prepared and evaluated. The ingredients are given in the following table:

| Ingredient | description |
|---|---|
| Water | tap water |
| Egg white powder | Spray dried albumin (about 81% protein) |
| Fruit fiber | natural citrus fiber (sugars and oils are removed) |
| Inulin1 | inulin syrup, soluble dietary fiber, in water |
| | (about 8% sugars) |
| Inulin2 | Inulin powder, long chain |
| Salt | NaCl |
| Baking powder | baking soda with an acid, and filler |
| Xanthan gum | stabilizing agent/thickener |
| Ground flax seed | ground seeds comprising dietary fibers and fatty acids |

Using the process conditions given below:
1. Solving inulin1 in warm water; mixing for 2 minutes (setting 2/3) (→clear solution)
2. Pre-mixing dry ingredients (Citrus fiber, salt, xanthan, flax seed) (→homogeneous mixture)
3. Mixer at setting 1, within 1 min. adding the dry mixture to the water with dissolved inulin1 (→no aggregations formed).
4. Mixer at setting 2 and mixing for 1.5 min. (→homogeneous mixture).
5. Mixer at setting 3 and mixing for 3.5 min. (→viscous mixture).
6. Remove (scrape) dry ingredients from side of the bowl (→left over powder removed from bowl).
7. Mixer at setting 2 and add protein powder within 1.5 min. (→no dust formation).
8. Mixing for 2 minutes with mixer at setting 3 (→batter).
9. Scrape dry ingredients from sides of bowl (→left over powder removed form side of the bowl).
10. Mixing for 1.5 minutes at setting 2 (→incorporation scrapings)
11. Mixing for 2 min. at setting 3 (→airy and sticky batter)
12. Gradually add baking powder during 30 sec. with mixer at op setting 1 (→no dust).
13. Mixing for 30 sec. at setting 2 (→no dust).
14. Mixing for 20 sec at setting 3 (→homogeneous distribution).
15. Coat the baking tin with a fat based release agent (→no sticking).
16. Fill the tin to about 2 centimeters below the rim (→prevent overflow).
17. Put the tin in the oven.
18. Preferably pre-steam (→may improve rising process)
19. Bake at 175° C. during 45 minutes (use other condition for yeast) (→leavened bread)
20. Remove bread immediately after baking from tin (→no sticking).

### Compositions of the Baking Composition (to be Baked)

| | Trial | Trial | Trial | Trial | Trial | Trial | Trial |
|---|---|---|---|---|---|---|---|
| Ingredients | 11.1 | 11.2 | 11.3 | 11.4 | 12.1 | 12.2 | 12.3 |
| Water | 68% | 68% | 68% | 60% | 65.5% | 70.5% | 65.5% |
| Egg white | 7.5% | 17.5% | 12.5% | 35% | 17.5% | 15% | 17.5% |
| powder | | | | | | | |
| Citrus fiber | 15% | 5% | 10% | 5% | 7.5% | 5% | 5% |
| Inulin1 | 7.5% | 7.5% | 7.5% | 0 | 7.5% | 7.5% | 7.5% |
| Salt | 0.4% | 0.4% | 0.4% | 0 | 0.4% | 0.4% | 0.4% |
| Baking | 1.2% | 1.2% | 1.2% | 0 | 1.2% | 1.2% | 1.2% |
| powder | | | | | | | |
| Xanthan | 0.4% | 0.4% | 0.4% | 0 | 0.4% | 0.4% | 0.4% |
| gum | | | | | | | |
| Flax seed | | | | | | | 2.5% |
| Total | 100 | 100 | 100 | 100 | 100 | 100 | 100 |

| | Trial | Trial | Trial |
|---|---|---|---|
| Ingredients | 13.1 | 13.2 | 13.3 |
| Water | 65.5% | 65.7% | 65.7% |
| Egg white | 17.5% | 17.7% | 17.7% |
| powder | | | |
| Citrus fiber | 5% | 5% | 5% |
| Inulin1 | | 7.5% | 7.5% |
| Inulin2 | 7.5% | | |
| Salt | 0.4% | 0.4% | 0.4% |
| Baking | 1.2% | 1.2% | 1.2% |
| powder | | | |
| Xanthan | 0.4% | 0 | 0.8% |
| gum | | | |
| Flax seed | 2.5% | 2.5% | 2.5% |
| Total | 100 | 100 | 100 |

### Quality Parameters

Stretchability, rupture of crumb, a crispy crust: Texture analyzer
Leavened volume and shape, resilience: Volscan (volume), C-cell, Texture analyzer
Size and wall thickness of crumb (cells): C-Cell
Doneness, moisture loss, moisture: Weighing, measuring core temperature, sensory evaluation
Crispness of the crust, browning of the crust: Sensory evaluation, LAB color measurement, Texture analyzer

### First Results

11.1: Rejection. Too compact, not airy. Lower limit protein/Upper limit fiber.
11.2: Good. Airy, resilient, good crust color, looks like white bread.
11.3: Rejection. Too compact, not airy. Lower limit protein/Upper limit fiber.
11.4: Rejection: Plastic appearance, off flavor, upper limit protein.
12.1: Acceptable. Less leavening volume. Upper limit fiber.
12.2: Rejection. Bread collapses during baking, compact, moist. Lower limit protein/Upper limit water.
12.3: Good. Like 11.2, but with a visual effect of flaxseed.
13.1 Good. No sugar, dry fiber replaces fiber syrup. Brown color disappears.
13.2: Rejection. Poorly raised, less airy bread, less volume. Lower limit xanthan
13.3: Good. Improved texture, more cells, more volume, less spongy, more bread-like.

Based on these results new trials have been performed with ingredient concentrations varied (relative to the total weight of the baking composition), see following table:

| | Trial | Trial | Trial | Trial | Trial | Trial |
|---|---|---|---|---|---|---|
| | 4.1 | 4.2 | 4.3 | 4.5 | 4.6 | 4.10 |
| Ingredients | [wt %] | [wt %] | [wt %] | [wt %] | [wt %] | [wt %] |
| Water | 63 | 63 | 65.2 | 67.5 | 69.5 | 63 |
| Egg white | 20 | 22.5 | 17 | 18 | 18.5 | 17.5 |
| powder | | | | | | |
| Citrus fiber | 5 | 2.5 | 5 | 2.5 | 0 | 4 |
| Inulinl | 7.5 | 7.5 | 7.5 | 7.5 | 7.5 | 4 |
| Salt | 0.4 | 0.4 | 0.4 | 0.4 | 0.4 | 0.3 |
| Baking | 1.2 | 1.2 | 1.2 | 1.2 | 1.2 | 10 |
| powder | | | | | | |
| Xanthan | 0.4 | 0.4 | 1.2 | 0.4 | 0.4 | 1.2 |
| gum | | | | | | |
| Flax seed | 2.5 | 2.5 | 2.5 | 2.5 | 2.5 | 0 |
| Total | 100 | 100 | 100 | 100 | 100 | 100 |

### Results

4.1: Good. More compact and crumb is firmer, smaller bubbles/cells
4.2: Rejection. Deformed and crust shines like plastic. Upper limit protein
4.3: Rejection. Deformed, undercooked, disproportional (strongly) leavened. Upper limit xanthan (solo)
4.5: Rejection. Deformed, plastic shine, too large cells, not uniformly cooked. Lower limit (citrus) fiber
4.6: Rejection. Like 4.5 but enhanced effects. Below lower limit (citrus) fiber
4:10: Good. Nice crumb, large bubbles, elastic like bread. Improved texture compared to 12.3.
4:10: Rejection. Salty, metallic taste, baking powder ingredient too high, porous crust, but very good airy texture

Based on the experiments the following preliminary technical limits can be deduced. Note: Not all possible combinations can be tested, see e.g. the outcome of trial 4.3 vs. 4.4 (both increase Xanthan, but the end result changes because of other relationships). The wt percentages are depicted relative to the total weight of the baking composition.

| Ingredient | wt % |
|---|---|
| Water | 60-70.5 |
| Egg white powder | 15-22.5 |
| Citrus fiber | 2.5-10 |
| Inulin1 | 4-7.5 |
| Salt | 0.3-0.4 |
| Baking powder | 1.2-10 |
| Xanthan gum | 0.4-1.2 |
| Ground flax seed | 0-2.5 |

Remark: In this mixture, especially, the water, the egg protein, the fiber ingredient(s), the leavening agent and the stabilizer seem most relevant. Inulin1 is a dietary fiber syrup (oligosaccharides) and can be exchanged with long chain inulin powder or a different dry dietary fiber. The total minimal amount of fiber (citrus+Inulin1+Inulin2 inulin) required and the maximum that still works are estimates. Total fiber is expected to be somewhere between 7.5 and 17.5 wt %. The data are based on the values of recipes that did not produce good result, and as such provide functional limits.

### Further Experiments

For scale up purposes, the process steps have been optimized/combined in further experiments. An average recipe used in these experiments is given in the next table:

| | Wt % | | Dry matter in |
|---|---|---|---|
| | On total | On dm | the ingredient |
| Ingredient | (wet) base | base | Wt % |
| Water | 54 | 0 | 0 |
| Sugars | 22 | 5.7 | 92 |
| Emulsifier | 0.5 | 1.4 | 99 |
| Egg white powder | 17 | 43.8 | 92 |
| Citrus fiber | 4.5 | 11.7 | 92.6 |
| Inulin2 | 4.5 | 12.2 | 97 |
| Improver (60% | 4.5 | 12.6 | 100 |
| fat, 40% | | | |
| emulsifier) | | | |
| Liquid yeast | 10 | 5.3 | 19 |
| Xanthan gum | 0.6 | 1.6 | 98 |
| Ground flax seed | 2.2 | 5.6 | 91 |
| Total | 100 | 100 | |

Average recipe used in the further experiments.

Using 1000 grams of the recipe and the process stages listed below, breads have been baked having a final weight of about 750-780 grams; i.e. during baking 22-25% (about 23-24% on average) of the total baking composition is lost as water.
1. Add about 50% of the water to a dough kneader already comprising all mixed dry ingredients and the fat;
2. Mix the ingredients to a firm batter;
3. Add the remainder of the water together with the liquid yeast and mix into a smooth slightly elastic batter (start the mixing slow and finish faster);
4. Coat the baking tin with a fat based release agent;
5. Fill the tin with 325-350 g batter;
6. Dough proof for about 30-35 min;
7. Bake at about 180-210° C. during 30-40 minutes;
8. Optionally: vacuum cool the breads during to a core temperature of 35-40° C.

To obtain a sensory result similar to three commercially prepared types of Dutch bread, i.e. a white bread (“wit brood”), a wholemeal/brown bread (“bruin brood”), and a whole grain bread (“volkorenbrood”), as well as a commercial prepared gluten free bread, a light brown food product (code BL) and a darker food product (code MZ) comprising extra seeds and extra brown colored fruit extract for a darker color have been produced, using the following recipes:

| | MZ | BL |
|---|---|---|
| Ingredient | wt % | wt % |
| Water | 49.5 | 53.75 |
| Sugars | 2 | 2.25 |
| Emulsifier | 0.4 | 0.5 |
| Roasted sesame seeds | 4.5 | |
| Roasted sunflower seeds | 4.5 | |
| Egg white powder | 15 | 17 |
| Citrus fiber | 4 | 4.5 |
| Inulin2 | 4 | 4.5 |
| Fat + emulsifier | 4 | 4.5 |
| Liquid yeast | 9 | 10 |
| Xanthan gum | 0.6 | 0.6 |
| Concentrated fruit extract | 1 | 0.5 |
| Ground flax seed | 1.5 | 1.9 |
| Total | 100 | 100 |

Recipes for the dark (MZ) and the light brown (BL) bread.

The commercial breads were prepared at the same time by the standard industrial process.

### Analysis of the Products

The products were analyzed with a Texture Analyzer and a C-Cell using standard methods approved by the American Association of Cereal Chemist (AACC), respectively the AACCI 74-09 and AACCI 10-18.01 method.

Hardness (also indicated as the elastic softness) of the crumb was determined with a Texture Analyser by means of a first measurement; wherein the force required to press a probe 20 mm into a cube of crumb having a thickness of 25 mm (one slice of 25 mm or two slices of 12.5 mm on top of each other) with a speed of 2 mm/s.

The degree of relaxation (also indicated as stickness) was determined by means of a second measurement: This measurement starts as the first measurement, but at the end the measure the probe is kept at 20 mm depth for 30 sec and then the force is measured again. The ratio of the second force to the hardness is the degree of relaxation.

Using a C-Cell colour, the number of cells per cm², cell diameter, cell wall thickness, cell elongation, cell volume, ratio cell area to total area of a slice (%), and the brightness of the slice were determined.

Next to the structural and textural aspects, the amount of digestible carbohydrates in the BL and MZ products were analyzed.

### Results

### Textural Aspect

The measured data including the standard deviation (std) of the texture analysis of the different types of bread are given in the next table.

| | max load | | relaxation | |
|---|---|---|---|---|
| Type | (gram force) | std | (%) | std |
| White | 245.08 | 35.15 | 28.94 | 1.95 |
| Brown | 171.15 | 33.09 | 29.02 | 1.97 |
| Whole | 178.75 | 12.67 | 30.51 | 1.5 |
| grain | | | | |
| BL | 401.23 | 26.03 | 37.2 | 0.57 |
| MZ | 312.77 | 20.07 | 39.43 | 0.16 |
| Gluten | 580.63 | 3.11 | 29.75 | 0.34 |
| free | | | | |

Hardness (compressibility) and relaxation of the samples

Normal bread (white, brown and whole grain) is softer than the BL and MZ samples. The commercial gluten free product was significantly harder than the BL and MZ samples. The relaxation percentages of the BL and MZ samples were a little higher than the commercial types of bread, indicating that the BL and MZ samples are more resilient. Above given results are for bread analyzed at the day of production. Further analyses were also performed using a penetrometer to determine the compressibility of the samples one day after production and two days after production (results not incorporated in this patent document). These experiments showed a large increase in the hardness and significant decrease in the relaxation percentages of the commercial breads at day 2 relative to day 1 after production, whereas the MZ and BL samples kept their initial compressibility (tenderness) It is assumed that this difference is due to the starch being present in all the commercial bread. Starch containing bread becomes stale in a short period, because of retrogradation of the starch. The food product of the invention contains substantially no starch and may keep its textural quality for an extended period (relative to commercial starch containing bread).

### Structural Aspects

The analyzed data obtained using the C-Cell measurements are given in the tables below:

Results C-Cell analysis

| | Number | | Cel | | Cell wall | | | |
|---|---|---|---|---|---|---|---|---|
| | of cells | | diameter | | thickness | | Cell | |
| | per cm² | | (mm) | | (mm) | | elongation | |
| Type | mean | std | mean | Std | mean | std | mean | std |
| White | 73.9 | 4.6 | 2.1 | 0.1 | 0.5 | 0.0 | 1.7 | 0.0 |
| Brown | 65.9 | 2.8 | 2.7 | 0.2 | 0.5 | 0.0 | 1.6 | 0.0 |
| Whole | 56.0 | 4.4 | 3.1 | 0.3 | 0.5 | 0.0 | 1.6 | 0.0 |
| grain | | | | | | | | |
| BL | 95.1 | 3.9 | 1.6 | 0.1 | 0.4 | 0.0 | 1.6 | 0.0 |
| MZ | 91.2 | 4.9 | 1.8 | 0.1 | 0.4 | 0.0 | 1.6 | 0.0 |
| GF | 80.7 | 4.4 | 1.9 | 0.1 | 0.5 | 0.0 | 1.5 | 0.0 |

Results C-Cell analysis, continued.

| | Cell volume | | Ratio Cell | | Brightness | |
|---|---|---|---|---|---|---|
| | (mm³) | | area (%) | | of the slice | |
| Type | mean | std | mean | std | mean | std |
| White | 6.4 | 0.4 | 52.6 | 0.4 | 152.7 | 0.2 |
| Brown | 9.9 | 0.7 | 54.3 | 0.3 | 112.6 | 0.4 |
| Whole | 11.9 | 1.2 | 55.4 | 0.5 | 95.8 | 0.3 |
| grain | | | | | | |
| BL | 5.3 | 0.3 | 49.4 | 0.3 | 138.6 | 1.4 |
| MZ | 6.4 | 0.3 | 50.5 | 0.2 | 120.0 | 0.7 |
| GF | 6.7 | 0.2 | 49.1 | 0.2 | 85.3 | 0.2 |

Based on these results, it is concluded that the structural parameters of the BL and MZ samples are comparable to the parameters of the commercial normal breads and the commercial gluten free (GF) bread. The measured structural parameters may fall in the ranges of the different types of commercial wheat starch and gluten free breads. The values of the structural parameters of the bread-like food product of the invention resemble the ones of the white bread the most.

### Digestible Carbohydrates

The total amount of digestible carbohydrates is given below based on the amount of starch and the amount of the total of sugars analyzed. Based on the analyzed values the amount based on a dry matter is calculated.

| Type | Type | Wt % | Wt % |
|---|---|---|---|
| product | carbohydrate | (tw) | (dm) |
| BL | Starch | 0.30 | 0.72 |
| | Total of sugars | 0.12 | 0.29 |
| | Total digestible carbohydrates | 0.42 | 1.01 |
| MZ | Starch | 0.30 | 0.72 |
| | Total sugars | 0.34 | 0.81 |
| | Total digestible carbohydrates | 0.64 | 1.53 |

Amount of digestible carbohydrates in the products; tw: based on total weight of the product (bread), dm: based on the dry matter weight of the product.

Conclusion: Even in the recipe comprising the carbohydrate containing sunflower seeds (MZ), the amount of digestible carbohydrates in the final product is less than 1 wt % and about 1.5 wt % based on the dry matter of the final product.

1. A process for a production of a baked food product, the process comprising:
baking a baking composition comprising a fiber, a protein, water, a leavening agent, and a stabilizer at a temperature selected in a range of 120° C. to 290° C. during a baking period selected in a range of 5 minutes to 120 minutes to provide the baked food product;
wherein the baking composition comprises a water amount selected in a range of 50-72.5 wt %, a protein amount selected in a range of 12-20 wt %, a fiber amount selected in a range of 5-17.5 wt %, a leavening agent amount selected in a range of equal to or less than 15 wt %, and a stabilizer amount selected in a range of 0.01-3 wt %, relative to a total weight of the baking composition, and wherein at least 50 wt % of the protein consist of albumin based on a dry matter weight of the protein; and
wherein the baked food product is a gluten-free bread-like food product.

2. The process according to claim 1, further comprising, before baking the baking composition:
mixing the fiber, the protein, the water, and the stabilizer to provide the baking composition.

3. The process according to claim 1, wherein the baking composition further comprises at least one of a fat, flax seed, or a digestible carbohydrate.

4. The process according to claim 3, wherein the baking composition further comprises the fat, wherein an amount of fat in the baking composition is selected from a range of 1-10 wt % relative to a total weight of the baking composition.

5. The process according to claim 3, wherein the baking composition further comprises the digestible carbohydrate, wherein a weight ratio of the digestible carbohydrate to the protein is equal to or less than 0.15.

6. The process according to claim 1, wherein an amount of the fiber in the baking composition is selected in the range 5-16 wt % relative to a total weight of the baking composition.

7. The process according to claim 1, wherein:
(i) the fiber comprises one or more of a citrus fiber and inulin, and/or
(ii) the fiber comprises a combination of a cold-swelling fiber and a texturizing fiber, wherein a ratio of the cold-swelling fiber to the texturizing fiber is selected from a range of 40:60 to 60:40.

8. The process according to claim 1, wherein the fiber comprises a combination of (i) a fruit fiber consisting of a citrus fiber and (ii) one or more of inulin and an inulin derivative, wherein a ratio of the one or more of the fruit fiber to the one or more of the inulin and the inulin derivative is selected from a range of ⅔ to 1.5.

9. The process according to claim 1, wherein the stabilizer comprises one or more stabilizers selected from the group consisting of mono-and di-glycerides of fatty acids and diacetyltartaric acid esters of mono-and diglycerides.

10. The process according to claim 1, wherein the stabilizer comprises xanthan gum in an amount of 0.5-2 wt %.

11. The process according to claim 1, wherein the leavening agent comprises a member of the group of yeast, baking powder, and baking soda.

12. The process according to claim 1, further comprising, before baking the baking composition:
proofing the baking composition at a temperature selected in a range of 5° C. to 65° C. during a proofing period selected in a range of 15 minutes to 240 minutes to provide a first rise to the baking composition.

13. The process according to claim 12, wherein the baking provides a further rise to the baking composition.

14. The process according to claim 1, further comprising, after baking the baking composition:
providing a vacuum to the baked baking composition, wherein the vacuum is configured for cooling a core of the baking composition to a core temperature selected from a range of 35° C. to 40° C.

15. The process according to claim 1, wherein the baked food product has a moisture content in a range of 45-60 wt %.

16. The process according to claim 1, wherein the baking comprises increasing a volume of the baking composition to provide the baked food product with a porosity in a range of 70-90 vol. %.

17. A process for a production of a baked food product, the process comprising:
(i) mixing a fiber, a protein, water, a leavening agent, a stabilizer to form a baking composition,
wherein:
the water is in a range of 50-72.5 wt %, the protein is in a range of 12-20 wt %, the fiber is in a range of 5-17.5 wt %, the leavening agent is in a range of 0-15 wt %, and the stabilizer is in a range of 0.01-3 wt %, relative to a total weight of the baking composition;
at least 50 wt % of the protein consist of albumin based on a dry matter weight of the protein; and
the baking composition has a first volume;
(ii) proofing the baking composition at a temperature selected in a range of 5° C. to 65° C. during a proofing period selected in a range of 15 minutes to 240 minutes to provide a first rise to the baking composition; and
(iii) baking the baking composition to form the baked food product, wherein the baked food product is a gluten-free bread-like food product with a water content in a range of 45-60 wt % and a porosity in a range of 70-90 vol. % and wherein the baked food product has a second volume that is 2-4 times the first volume.
